(19) United States
(12) Patent Application Publication
(10) Pub. No.: US 2015/0351378 A1
(43) Pub. Date: Dec. 10, 2015

(54) SELF EMPTYING RAT TRAP FOR DUMPSTERS AND RESIDENTIAL WASTE CARTS

(71) Applicants: James Frankland ZERO, New Oxford, PA (US); Douglas Bradford HOWARD, Severna Park, MD (US)

(72) Inventors: James Frankland ZERO, New Oxford, PA (US); Douglas Bradford HOWARD, Severna Park, MD (US)

(21) Appl. No.: 14/298,255

(22) Filed: Jun. 6, 2014

(51) Int. Cl. A01M 23/08; A01M 23/22

(52) U.S. Cl. CPC A01M 23/08; A01M 23/22

(57) ABSTRACT

A waste cart may be provided. The waste cart may include a housing having a top wall and a plurality of outer walls enclosing an interior space. The interior space may include a bait stick connected and extending therein. The housing may have an entranceway providing access to the interior space. The entranceway may include a passageway having a rotatably mounted plurality of tines adapted to allow one-way access into the interior space. The top wall may be pivotably connected to the housing. The top wall may be secured by a gravity locking mechanism adapted to release the top wall under the force of gravity when the waste cart is inverted, such as when the waste cart is fixed to the inside of a inversion-dumped trash bin.

### BACKGROUND OF THE INVENTION

The present invention relates to pest control and, more particularly, to a device for providing a safe and sanitary means of trapping and disposing of rodents.

The problem with current rat traps or bait boxes is that they are not totally secure from children or pets getting into them or handling them, and so require routine monitoring. Also, such rat traps require that they be emptied manually on a regular basis, and they allow the rats to die elsewhere. All of these could create health issues.

As can be seen, there is a need for a rodent trap device that secures the trapped rodent from exposure to children and pets, and that does not require manual emptying.

### SUMMARY OF THE INVENTION

In one aspect of the present invention, a trap for rodents comprises: a housing enclosing an interior space for containing a trapped animal, wherein the housing comprises: a plurality of outer walls; a top wall, wherein the top wall is pivotably connected to one outer wall; and a front wall, wherein the front wall defines an opening providing access to the interior space; and a gravity locking mechanism securing the top wall to the housing

In another aspect of the present invention, a method of sanitarily trapping a rodent comprises: providing a trap for rodents comprising: a housing enclosing an interior space for containing a trapped animal, wherein the housing comprises: a plurality of outer walls; a top wall, wherein the top wall is pivotably connected to one outer wall; and a front wall, wherein the front wall defines an opening providing access to the interior space; and a gravity locking mechanism securing the top wall to the housing; securing poisoned bait within the interior space; and attaching the trap for rodents to the interior of a trash bin so as to be out of reach of children and pets, and so that gravity locking mechanism is inverted when the trash bin is dumped.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention in an open position;

FIG. 3 is an exploded view of an exemplary embodiment of the present invention;

FIG. 4 is a front view of an exemplary embodiment of the present invention;

FIG. 5 is a section detail view of an exemplary embodiment of the present invention along line 5-5 in FIG. 4;

FIG. 6 is a section view of an exemplary embodiment of the present invention; and

FIG. 7 is a section view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention may include a waste cart. The waste cart may include a housing having a top wall and a plurality of outer walls enclosing an interior space. The interior space may include a bait stick connected and extending therein. The housing may have an entranceway providing access to the interior space. The entranceway may include a passageway having a rotatably mounted plurality of tines adapted to allow one-way access into the interior space. The top wall may be pivotably connected to the housing. The top wall may be secured by a gravity locking mechanism adapted to release the top wall under the force of gravity when the waste cart is inverted, such as when the waste cart is fixed to the inside of a inversion-dumped trash bin.

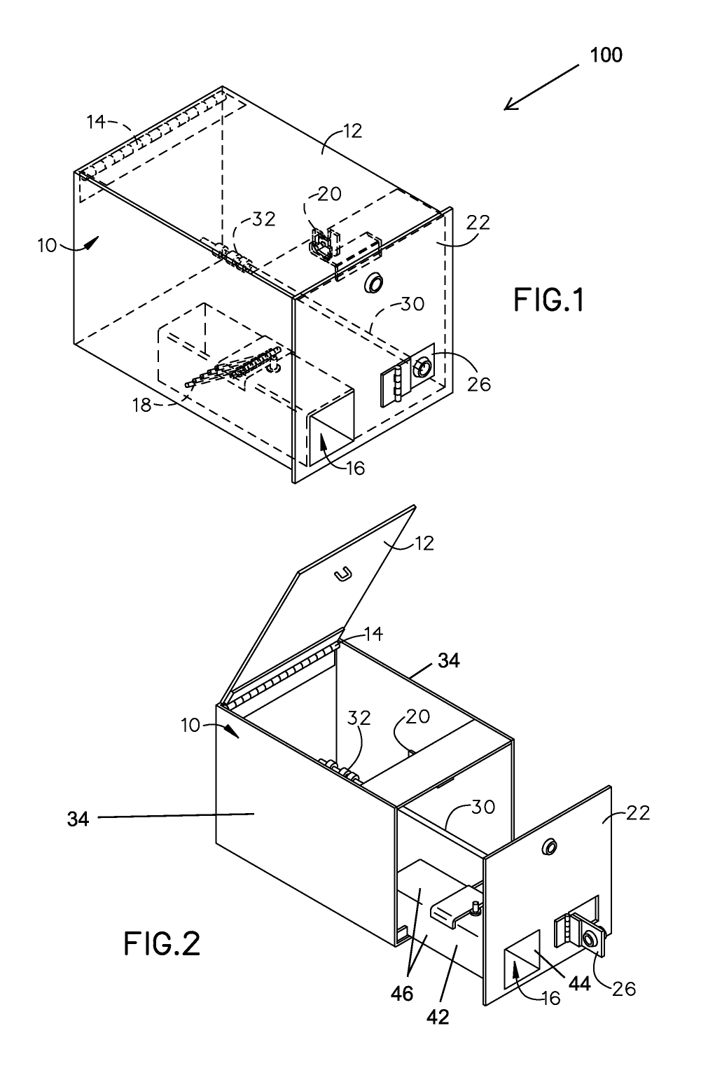

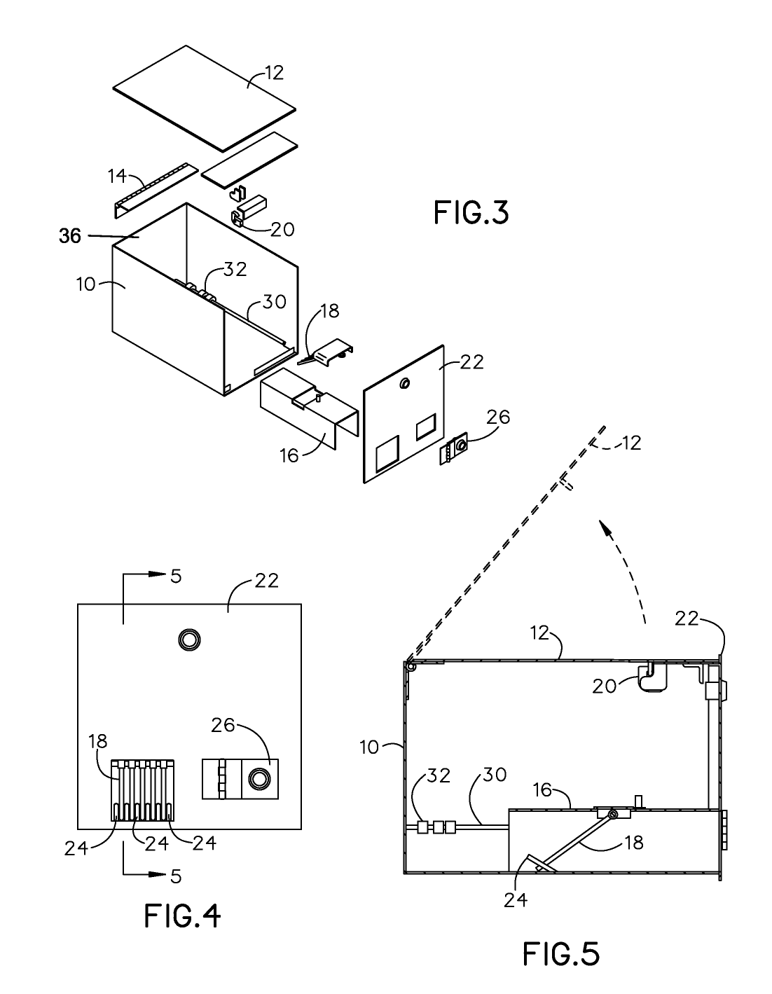

Referring to FIGS. 1 through 7, the present invention may include a waste cart 100. The waste cart 100 may be made of a material, such as 14 gauge steel or the like, with substantial strength to absorb impact common to the inside of a trash bin. The waste cart 100 may include a box-like housing 10 including a top wall 12, a front wall 22 and a plurality of outer walls such as opposed side walls 34, a back wall 36, a bottom wall; all defining an interior space. The dimensions of the box-like housing 10 may vary depending on need and not depart from the spirit of the present invention.

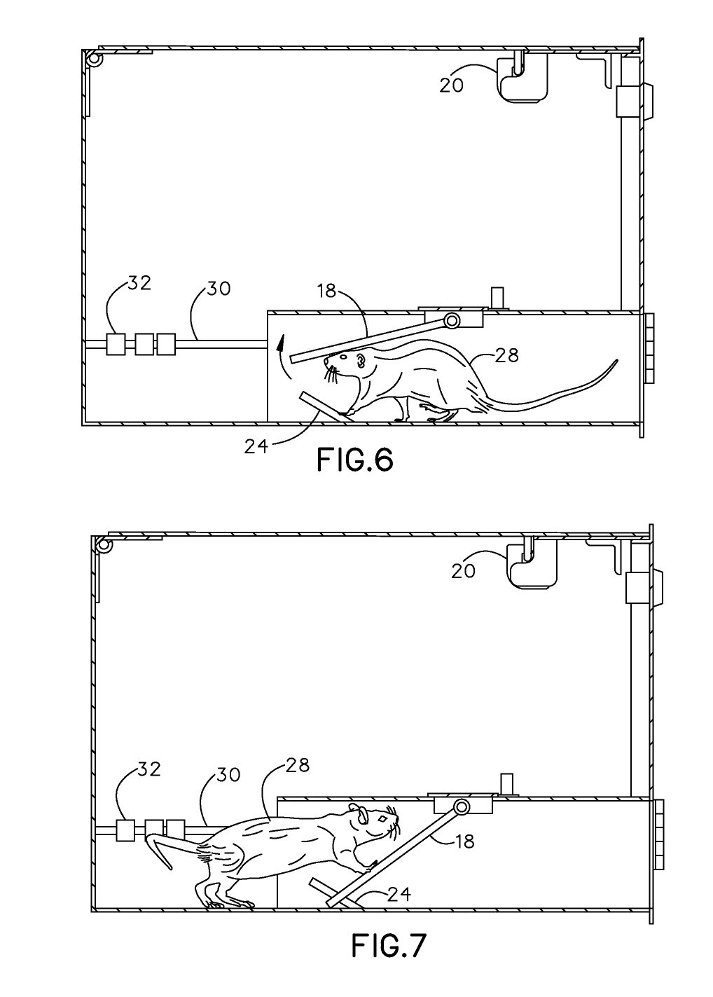

An elongated passageway 16 may provide access to the interior space via an opening 44 in the front wall 22. The elongated passageway 16 may be defined by a plurality of side walls 46. The plurality of side walls 46 may be in common with at least one side wall 34 and/or the bottom wall as when the elongated passageway 16 may be located along a lower side wall corner. The passageway 16 may include a plurality of tines 18 pivotably mounted therein. The plurality of tines 18 may be dimensioned so as to block substantially all of the passageway 16. In certain embodiments, the passageway 16 may include a plurality of bottom rods 24 so that the plurality of bottom rods 24 and the plurality of tines 18 mesh so as to block substantially all of the passageway 16. The plurality of tines 18 may be rotatably movable as a singular unit between a generally downwardly directed position and a rotated position, as illustrated in FIG. 6. The tines 18 may be mounted with a spring hinge so as to biased toward the downwardly directed position although an unbiased configuration would also work. The generally downwardly directed position may be adapted so that an animal 28 trapped within the interior space may only manipulate the plurality of tines 18 while standing on them so that the animal's 28 own body weight will not allow the plurality of tines 18 to move. The plurality of tines 18 may provide spacing to pass bait odors into the passageway 16 so as to entice the animal 38 into the opening 44 and through the plurality of tines 18.

The top wall 12 may be pivotably connected by a hinge 14 to the housing 10 so as to rotatably move to and from an open position and a closed position. The top wall 12 may be secured by a gravity locking mechanism 20 adapted to open in an inverted position, such as for example, when the trash bin the waste cart 100 is secured to is being inverted so as to be dumped. In the inverted position the gravity locking mechanism 20 may release the top wall 12 under the force of gravity so that the top wall pivots under its own weight toward the open position, as illustrated in FIG. 5. The gravity locking mechanism 20 may be connected to the front wall 22 and/or a flange perpendicularly joined to the front wall 22, as illustrated in FIG. 5. The gravity locking mechanism 20 may be adapted to automatically secure the top wall 12 to the housing 10 when the waste cart 100 is rotated back to a standard position from the inverted position, thereby securing the interior space from access to pets or children.

A bait stick 30 may be connected within the interior space, as illustrated in FIG. 1. The bait stick 30 may be accessible through the front wall 22 via a bait opening adapted to be secured by a hinged bait door 26. The bait stick 30 may be a rod or the like that skewers at least one bait nugget 32 so that the at least one bait nugget 32 remains secured thereto when the waste cart 100 is in the inverted or the standard position. The at least one bait nugget 32 may be poisonous when consumed by the animal 28.

A method of using the present invention may include the following. A user may skewer at least one poisoned bait nugget 32 onto the bait stick 30. The user may attach the waste cart 100 to the inside of a trash bin, dumpster, toter, residential waste cart, or the like waste receptacle that is inverted when disposing of its contents. The waste cart 100 is attached in a standard position and the top wall 12 is in the closed position secured by the gravity locking mechanism 22 so that the waste cart 100 would move to the inverted position and the top wall 12 to the open position when the trash bin is being dumped.

It should be understood, of course, that the foregoing relates to exemplary embodiments of the invention and that modifications may be made without departing from the spirit and scope of the invention as set forth in the following claims.

What is claimed is:

1. A trap for rodents comprising:
a housing enclosing an interior space for containing a trapped animal, wherein the housing comprises:
a plurality of outer walls;
a top wall, wherein the top wall is pivotably connected to one outer wall; and
a front wall, wherein the front wall defines an opening providing access to the interior space; and
a gravity locking mechanism securing the top wall to the housing.

2. The trap for rodents of claim 1, further including a one-way access through the opening and into the interior space.

3. The trap for rodents of claim 1, further including a passageway formed by a plurality of sidewalls, wherein the passageway interconnects the opening and the interior space.

4. The trap for rodents of claim 3, wherein at least one of the sidewalls is in common with at least one outer wall.

5. The trap for rodents of claim 3, further including a plurality of tines pivotably connected within the passageway so as to provide one-way access into the interior space.

6. The trap for rodents of claim 5, wherein the plurality of tines rotate to and from a downwardly directed position, whereby an animal trapped within the interior surface may only manipulate the plurality of tines while standing thereon.

7. The trap for rodents of claim 1, further including a bait stick connected within the interior space.

8. A trap for rodents comprising:
a housing enclosing an interior space for containing a trapped animal, wherein the housing comprises:
a plurality of outer walls;
a top wall, wherein the top wall is pivotably connected to one outer wall; and
a front wall, wherein the front wall defines an opening providing access to the interior space;
a gravity locking mechanism securing the top wall to the housing;
a passageway formed by a plurality of sidewalls, wherein the passageway interconnects the opening and the interior space;
a plurality of tines pivotably connected within the passageway so as to provide one-way access into the interior space; and a bait stick connected within the interior space.

9. A method of sanitarily trapping a rodent comprising:
providing a trap for rodents comprising: a housing enclosing an interior space for containing a trapped animal, wherein the housing comprises: a plurality of outer walls; a top wall, wherein the top wall is pivotably connected to one outer wall; and a front wall, wherein the front wall defines an opening providing access to the interior space; and a gravity locking mechanism securing the top wall to the housing;
securing poisoned bait within the interior space; and
attaching the trap for rodents to the interior of a trash bin so as to be out of reach of children and pets, and so that gravity locking mechanism is inverted when the trash bin is dumped.
